(19) United States
(12) Patent Application Publication
(10) Pub. No.: US 2009/0320460 A1
(43) Pub. Date: Dec. 31, 2009

(54) Aircraft Auxiliary Systems Pump

(76) Inventor: Robert Peterson, Canby, OR (US)

Correspondence Address: BULLIVANT HOUSER BAILEY PC, 1415 L STREET, SUITE 1000, SACRAMENTO, CA, 95814, US

(21) Appl. No.: 12/147,124

(22) Filed: Jun. 26, 2008

(51) Int. Cl. F16D 31/02

(52) U.S. Cl. 60/417

(57) ABSTRACT

The invention provides methods and systems for starting auxiliary systems, comprising an auxiliary pump system having: a) a motorpump assembly having a constant displacement pump coupled to an electric motor; b) a hydraulic accumulator in fluid communication with said motorpump assembly; and c) lines to at least on auxiliary system in fluid communication with said motorpump assembly.

### BACKGROUND OF THE INVENTION

1. Copyright Notice

A portion of the disclosure of this patent document contains material that is subject to copyright protection. The copyright owner has no objection to the facsimile reproduction by anyone of the patent document or the patent disclosure, as it appears in the Patent and Trademark Office patent files and records, but otherwise reserves all other copyright rights.

2. Field of the Invention

The present invention relates to hydraulically actuated aircraft engine control systems, more particularly for an improved pump for initiating auxiliary power for such a system.

3. Description of Related Art

An auxiliary power unit (APU) is a device on a vehicle whose purpose is to provide power for other than the propulsion systems. APUs are most commonly deployed on aircraft, but have also been used on some larger ground vehicles.

On many aircraft, APU systems provide hydraulic power to a secondary set of hydraulically controlled systems. Present day aircraft engines are highly sophisticated and, in order to improve their performance they include separate systems for controlling switches, valves and cutoffs.

A primary purpose of an aircraft APU is to provide power to start the main engines. Turbine engines have large, heavy rotors that must be accelerated to a high rotational speed in order to provide sufficient air compression for self-sustaining operation. This process takes significantly longer and requires much more energy than starting a reciprocating engine. Smaller turbine engines are usually started by an electric motor, while larger turbine engines are usually started by an air turbine motor.

APUs also power numerous auxiliary functions. Electrical and pneumatic power may be used to run the heating, cooling, and ventilation systems prior to starting the main engines. This allows the cabin to be comfortable while the passengers are boarding without the expense, noise, and danger of running one of the aircraft's main engines. Electrical power is also used to power up systems for preflight checks.

Whether the starter is electrically or pneumatically powered, the amount of energy required is typically far greater than what could be provided by a storage device (battery or air tank) of reasonable size and weight.

An APU solves this problem by powering up the aircraft in two stages. In one approach, a hydraulic APU is started by an electric motor, with power supplied by a battery or external power source (ground power unit). After the APU accelerates to full speed, it can provide a much larger amount of power to start the aircraft's main engines, either by turning an electrical generator or by compressing air.

APUs are also frequently connected to a hydraulic pump, allowing maintenance and flight crews to operate hydraulic flight controls and power equipment without running the main engines. This same function is also used as a backup in flight in case of an engine failure or hydraulic pump failure. Modern aircraft typically have at least one hydraulic control circuit for controlling the aircraft control surfaces, the operation of the landing gear, etc. with an independent pressurized fluid source, which delivers a pressurized hydraulic fluid to the control circuit to control these structures.

A different approach is to use accumulated hydraulic pressure and initiate the APU system. Using a hydraulic start motorpump, in one mode the motorpump is powered by hydraulic fluid supplied under pressure from the accumulator to run the APU on start-up, while in a second mode the motorpump drives the accumulation of hydraulic pressure for subsequent starts.

U.S. Pat. No. 5,237,815, describes a fluidic starter for turbines using a flow limiter and a mechanical valve that is maintained closed until an operator moves a handle to provide fluid which has passed through the flow limiter to a starter motor mechanically connected to the turbine. The handle is latched so the valve is open until the turbine is started then the handle is unlatched and the valve closes.

U.S. Pat. No. 5,873,548, describes an aircraft hydraulic system that maintains a continuity of hydraulic power from an aircraft engine-driven hydraulic pump to a first set of propulsion control hydraulic loads for controlling the aircraft engine. The system includes an accumulator coupled to the engine-driven hydraulic pump suction.

U.S. Pat. No. 7,104,072, provides a starting system for starting the propulsion engines of gas turbine powered aircraft that combines power sources delivered by the APU, where the power delivered by the APU for pneumatic, hydraulic and electric power is applied to corresponding starters on each propulsion engine during main engine start simultaneously.

The D model Chinook has two 3,500 (4,500 emergency) horsepower gas turbines and the T62 APU gas turbine linked by Marc. The T62 in the Chinook weighs about 70 pounds and puts out 65 horsepower. For the United States Army, starting the T62 is necessary for stating the main engines, and requires pressurizing a 3,500 psi hydraulic accumulator by hand pump. The hand pump is a manually operated pump with dual action, and is primarily used to pressurize the APU start accumulator to subsequently start the APU

Where the function is to provide auxiliary standby power during flight and for system checkouts on the ground, existing systems all either require actuation of the hydraulic system manually, or are engineered as a complex system with many interrelated operations and potential sources of failure. The United States Army initiated the Electrical Pump for Utility System Hydraulic Accumulator (EPUSHA) project for the Chinook helicopter program to provide an APU system using electrical power instead of manpower to “prime” the start accumulator for the Auxiliary Power. In addition to reliability, a chief requirement of systems for military aircraft, particularly helicopters, is weigh reduction.

Thus, in spite of the ongoing developments in the art, existing hydraulic pumps for APU systems remain either too complex, cumbersome to operate or have an unacceptably high failure rate.

### SUMMARY OF THE INVENTION

The present invention provides a pump system for a hydraulic APU to supply hydraulic fluid to a first set of propulsion control hydraulic loads when the second set of airframe hydraulic loads has been isolated.

The invention provides methods and systems for starting auxiliary systems, comprising an auxiliary pump system having: a) a motorpump assembly having a constant displacement pump coupled to an electric motor; b) a hydraulic accumulator in fluid communication with said motorpump assembly; and c) lines to at least on auxiliary system in fluid communication with said motorpump assembly.

The pump system may comprise a filter for the fluid, as the hydraulic fluid is repeatedly circulated through the utility system.

In one embodiment, the motorpump assembly weighs less than about 18 lbs, though in preferred embodiments, it weighs less than about 16 lbs, and even less than about 14 lbs.

In another preferred embodiment, the pump and motor are coupled by direct drive.

The electric motor delivers power at least about 40 amps, though preferably the power is at least about 60 amps, and even as much as 80 amps or more.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 is a schematic of the hydraulic accumulator system used with an aircraft APU system;

FIG. 2 shows the hydraulic pump assembly for an aircraft APU system;

FIG. 3 depicts a schematic of a hydraulic accumulator for use the APU system;

FIG. 4 shows the pump section of the hydraulic motor pump assembly in plan view;

FIG. 5 shows the end view of the pump of FIG. 3 from the perspective of the drive end;

FIG. 6 shows a fluid output end view for the pump of FIG. 3;

FIG. 7 is a cross-section view showing the internal components of the pump of FIG. 3;

FIG. 8 shows the motor section of the hydraulic motor pump assembly;

FIG. 9 shows an end view of the motor of FIG. 7;

FIG. 10 shows the opposite end view of the motor of FIG. 8;

FIG. 11 shows a plan view of a filter for use with the pump assembly; and

FIG. 12 is a cross sectional view of the filter of FIG. 10.

### DETAILED DESCRIPTION OF THE INVENTION

The structure and operation of conventional APU systems, as well as associated hydraulic and electrical systems, are well known in the art. Examples are set forth in the U.S. and foreign patent documents listed above, the teachings of which are incorporated herein by reference as if set forth herein in their entirety.

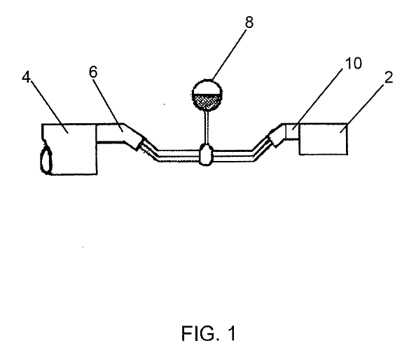

As shown in FIG. 1, the APU system 2 is tied to a main engine 4, which typically has a hydraulic starter motor 6 connected to a discharging hydraulic accumulator 8. The hydraulic accumulator 8 is used to power a hydraulic motorpump assembly 10 that starts the APU. The motorpump assembly 10 supplies a non-pulsating fluid flow, as required, for initiation of an aircraft APU system 2.

As exemplified for the Chinook helicopter, pressure from the accumulator 8 is released to the motorpump assembly 10 when the APU is started. The motorpump assembly 10 is mechanically coupled to the forward end of the APU. When serving as a motor, the motorpump assembly 10 receives hydraulic pressure from the APU start accumulator to drive the APU to starting speed.

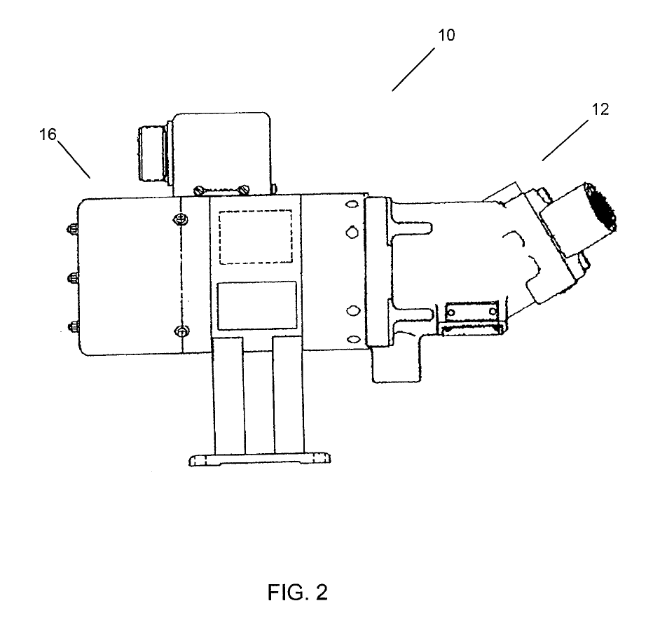

When the APU starts, it then drives the motorpump assembly 10 as a pump. As a pump, it supplies pressurized hydraulic fluid at 3,350 psi to start the engines or to power utility subsystems. In reference to FIG. 2, a hydraulic motorpump assembly of the invention is depicted, consisting generally of a DC electric motor driven constant displacement, hydraulic pump 10. The motorpump assembly 10 generally comprises a hydraulic output pump 12 coupled to an electric motor 16. To reduce weight, the drive on pump 12 is engineered to directly couple the output drive of the electric motor 16 to the pump 12.

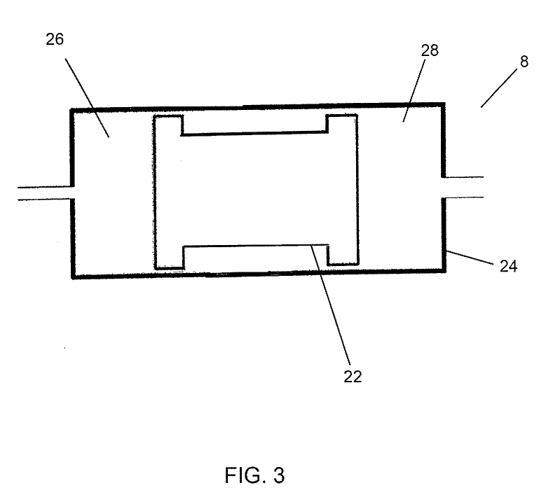

Various forms of hydraulic accumulators 8 are well known to the art, and many can be adapted for use with the invention. Basic accumulators, as shown schematically in FIG. 3, are simple devices that comprise a piston 22, a cylinder 24, and pneumatic and fluid ends, 26 and 28 respectively. Pressure from an aircraft hydraulic system enters the fluid side 28 and forces the piston 22 toward the pneumatic end 26 of the cylinder 24. As the piston 22 is forced away from the fluid end 28, it compresses the trapped gas on the pneumatic side 26, the source of stored pressure. The incompressibility of one fluid (hydraulic oil) and the highly compressible nature of the other fluid (nitrogen or air) are used to store the pressure.

Another type of accumulator 8 is the self-displacing variety, not shown, which has three chambers, with two piston heads attached together by a common rod. This type of accumulator is used in some hydraulic systems where reservoir volume is small or speed of operation is important.

When pressures equalize, the piston rod 29 stops moving and the accumulator 8 can store a predetermined amount of pressurized fluid. A check valve from the pressure supply, and selector/shut-off valves, are used to maintain the pressurized fluid in the accumulator until it is needed to perform work.

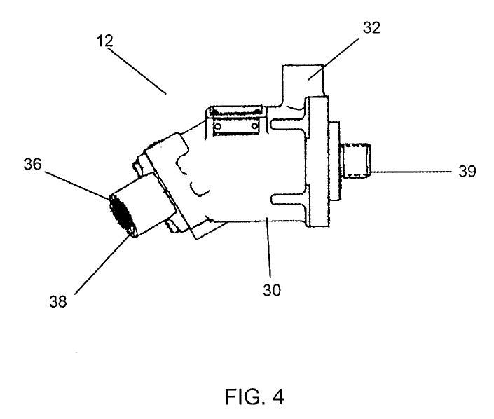

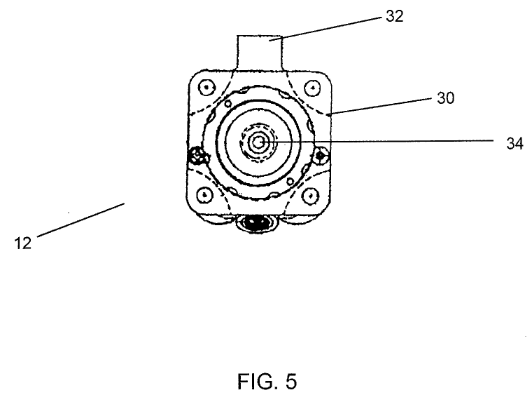

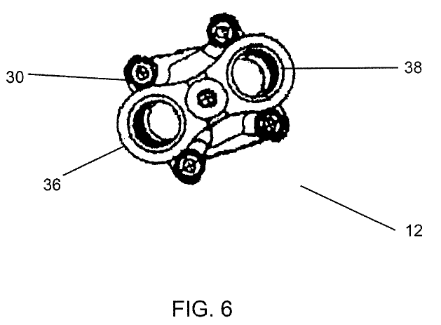

The pump 12 is engineered to be used in hydraulic circuits to convert hydraulic power into rotary mechanical motion. Looking in more detail at the pump 12, as depicted in FIGS. 4, 5 and 6, pump 12 generally comprises a housing 30 and mounting flange 32, which are cast as an integral unit. The pump 12 has a coupling shaft 34 at one end (FIG. 5) and fluid inlet and outlet portals 36 and 38, respectively, at the other end (FIG. 6).

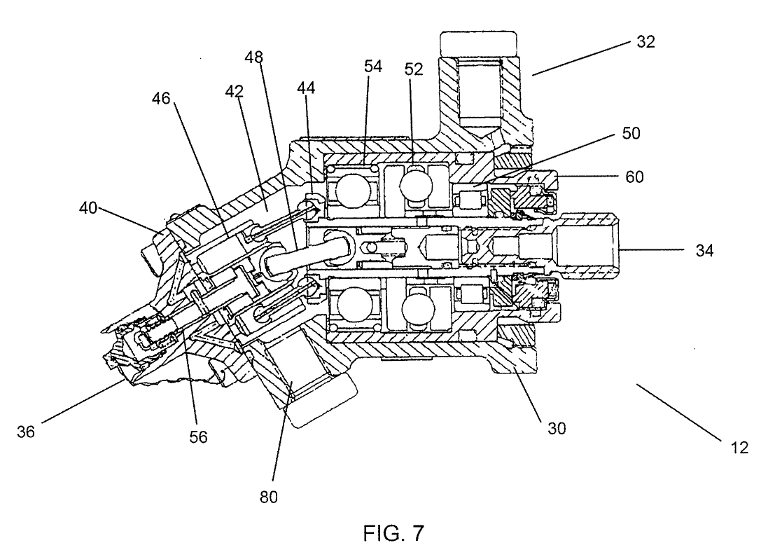

Looking to FIG. 7, in cross section it is seen that the pump housing 30 encases a valve plate 40 and rotating group subassembly 42. Rotating group subassembly 42 includes a shaft and pistons subassembly 44, cylinder block 46, universal link and pins subassembly 48, and rear radial bearing 50, thrust bearing 52, front radial bearing 54 and cylinder bearing pin and bearing subassembly 56.

Universal link and pins subassembly 48 connects the shaft and pistons subassembly 44 and cylinder block 46 to keep them rotating together. Rotating group subassembly 42 is supported at the drive shaft end by rear radial bearing 50, thrust bearing 52 and front radial bearing 54 and at the valve plate end by the cylinder bearing pin and bearing subassembly 56 within the cylinder block.

As the rotating group subassembly rotates within the housing, the housing provides a fixed angle of offset between the cylinder block and the drive shaft. This angle is referred to as the “angle of displacement”. Hydraulic fluid is contained in the housing by shaft seal subassembly 58 in bearing retainer 60. The fluid lubricates internal parts.

The valve plate 40, mounted on the housing 30, directs high-pressure fluid from the system through the inlet port to the pistons in the cylinder block 48. This high-pressure fluid forces the pistons away from the valve plate 40, creating rotation of the cylinder block 48 and drive shaft 34. At the end of the piston stroke the cylinder block 40 has rotated 180° and the pistons now become associated with the outlet (low pressure) cycle. On their return stroke, pistons force fluid at low pressure through the outlet port 36 or 38 to the system return lines.

The pump may be operated continuously, intermittently, continuously reversed, or stalled without damage when operated at rated pressures and in a system incorporating an adequate overload relief valve.

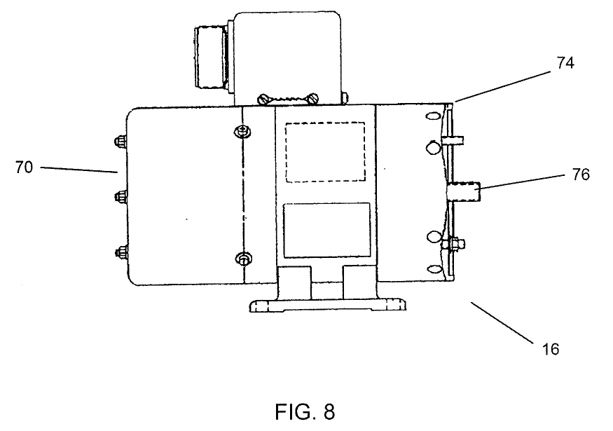

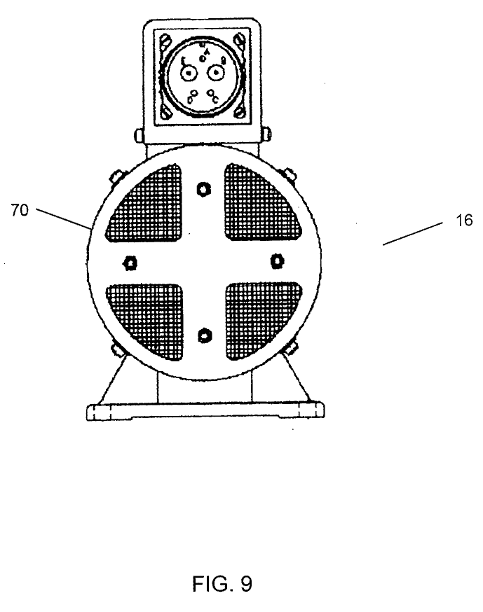

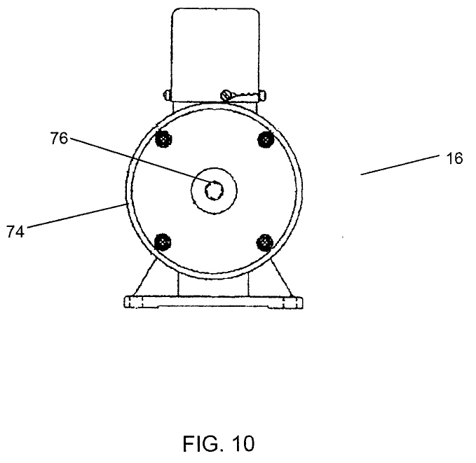

The electric motor 16 (FIGS. 8, 9 and 10) is an explosion-proof fan (air) cooled, 80 amp unit. The motor has a fan end 70 and a mounting flange 74 at the other end for mounting to the pump. The coupling to the motor drive shaft 76 is at the flange end.

Referring again to FIG. 7, when the electric motor 16 is operating, the cylinder block 46 is driven in a rotary motion by universal link and pins subassembly 48 via the coupling shaft 34 connected to electric motor output shaft 76. The cylinder block 46 is so mounted that it is free to rotate at a fixed angle with respect to the coupling shaft 34.

In addition to the normal flow of fluid to outlet port, there is an internal low-pressure fluid circuit to provide internal lubrication and cooling flow to pump moving components. A small amount of total pump flow will be diverted through passages and clearances within and between pump components to perform lubrication and cooling flow and to maintain hydraulic balance within the pump.

A case drain port 80 in the housing 30 is connected by line to the hydraulic reservoir to prevent the development of excessive case pressure within the housing. This line is formed and routed in such a manner as to ensure that the housing remains full of fluid constantly.

A hydraulic motor is a device that generates rotary motion directly from the hydraulic system. Hydraulic motors give a steady, continuous torque. They are small and compact.

To convert a hydraulic pump into a hydraulic motor, several changes were adopted by the prior art, which felt compelled to include a gearbox on the shaft. When a hydraulic pump is connected to a selector valve, the hydraulic oil coming into the pump pushes down on the pistons, causing the whole piston assembly to rotate. If this assembly is connected to a shaft, the shaft will rotate with great rotational speed.

In prior hydraulic motors, a gear reduction box was typically attached to the pump to reduce the rotational speed to a useable range. By reengineering the system to a direct driving system, the model is smaller and lighter in weight and suitable for aircraft APU systems.

The motor/pump assembly of the invention reduces the amount of time to charge an APU system from 3 minutes to approximately 45 seconds.

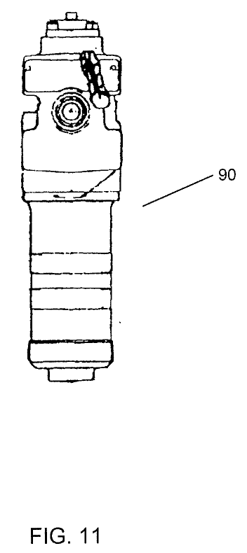

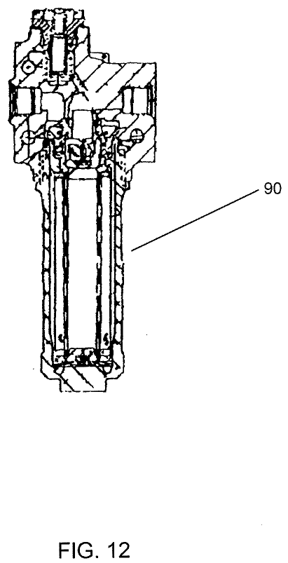

FIGS. 11 and 12 depict filters 90 that can be installed into the system to prevent utility system contamination and failure. A check valve, can also be installed on the outlet side of the filter.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. An auxiliary pump system comprising:
a) a motorpump assembly having a constant displacement pump coupled to an electric motor;
b) a hydraulic accumulator in fluid communication with said motorpump assembly; and
c) lines to at least on auxiliary system in fluid communication with said motorpump assembly.

2. The pump system of claim 1 further comprising a filter for the fluid.

3. The pump system of claim 2 wherein the fluid is engine oil.

4. The pump system of claim 4 wherein the motorpump assembly weighs less than about 18 lbs.

5. The pump system of claim 1 wherein the motorpump assembly weighs less than about 16 lbs.

6. The pump system of claim 1 wherein the motorpump assembly weighs less than about 14 lbs.

7. The pump system of claim 1 wherein the pump and motor are coupled by direct drive.

8. The pump system of claim 1 wherein said electric motor delivers power at least about 40 amps.

9. The pump system of claim 1 wherein said electric motor delivers power at least about 60 amps.

10. The pump system of claim 1 wherein said electric motor delivers power at least about 80 amps.

11. A method for starting the auxiliary power of an aircraft, said method comprising the steps of:
a) accumulating hydraulic fluid under pressure in an accumulator by the action of a motorpump assembly, said motorpump assembly comprising a constant displacement pump directly coupled to an electric motor;
b) storing said hydraulic fluid under predetermined pressure conditions; and
c) pumping said hydraulic fluid to power at least one of an auxiliary system and a hydraulic engine startup system.

12. The method of claim 11 further comprising a filter for the fluid.

13. The method of claim 12 wherein the fluid is engine oil.

14. The method of claim 14 wherein the motorpump assembly weighs less than about 18 lbs.

15. The method of claim 11 wherein the motorpump assembly weighs less than about 16 lbs.

16. The method of claim 11 wherein the motorpump assembly weighs less than about 14 lbs.

17. The method of claim 11 wherein the pump and motor are coupled by direct drive.

18. The method of claim 11 wherein said electric motor delivers power at least about 40 amps.

19. The method of claim 11 wherein said electric motor delivers power at least about 60 amps.

20. The method of claim 11 wherein said electric motor delivers power at least about 80 amps.
